(19) United States
(12) Patent Application Publication
(10) Pub. No.: US 2007/0055963 A1
(43) Pub. Date: Mar. 8, 2007

(54) Compile target and compiler flag extraction in program analysis and transformation systems

(75) Inventors: Daniel G. Waddington, Tinton Falls, NJ (US); Bin Yao, Middletown, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies, Inc.

(21) Appl. No.: 11/222,099

(22) Filed: Sep. 8, 2005

(51) Int. Cl. G06F 9/45

(52) U.S. Cl. 717/140

(57) ABSTRACT

A technique for automatically identifying source files and the compile time flags for each file used in building an executable program and recording this information in a data format that can be used by a code analysis and transformation system is provided.

### FIELD OF THE INVENTION

The present invention relates generally to the field of program analysis and transformation and, in particular, relates to identifying and recording information for compiling source code.

### BACKGROUND OF THE INVENTION

In code analysis and transformation systems, an important issue is getting an accurate version of source code for the specific version of the program under investigation. There are two aspects of this problem. The first aspect is identifying all the source files that are included in the program. In large software projects, the source directory typically contains files that are used in building functionally different programs. Source files may also be dynamically generated during the make process by tools such as bison and lex. Including or excluding files based only on the directory structure may not be correct. The second aspect is getting the correct version for all files. Source files may (and most of them do) contain #ifdef directives that selectively include statements. Based on the provided flags, such as -D XYZ, a single source file can result in different compiled code. This is typically done so that the program can compile correctly for different operating systems and/or for different processors. It is desirable to be able have an automated way to obtain the files used in building a program and the exact compiler flags used for each file. This information can then be used as input to any program analysis and transformation system.

One existing approach is to modify the make file. In this approach, compile commands are changed to custom pre-process commands and link commands are changed so that the pre-processed files can be loaded into memory for analysis. Another approach is to examine the make file or make file output manually to identify compile options and compiled files. Manual examination can be error prone and time consuming. Modifying make files can be difficult, especially if each directory involved has its own make file. Additionally, in many large projects, make files are auto-generated using autoconf/automake. These make files may need to be modified every time they are generated due to configuration changes.

### SUMMARY

Various deficiencies of the prior art are addressed by various exemplary embodiments of the present invention of a method for compile target and compiler flag extraction in program analysis and transformation systems.

One embodiment is a method of identifying source file names and their associated compile time flags by examining a build output file. The source file names name each file used in building one or more executable program(s) with the associated compile time flags. Any relative paths in the source file names are resolved to absolute paths, producing absolute source file names. The absolute source file names and the associated compile time flags are recorded in a data format that is stored on a storage device. Another embodiment is a computer-readable medium having instructions for performing this method.

### BRIEF DESCRIPTION OF THE DRAWINGS

The teachings of the present invention can be readily understood by considering the following detailed description in conjunction with the accompanying drawings:

FIG. 1 illustrates an overall approach of exemplary embodiments for extracting information from an exemplary build output file;

FIG. 2 illustrates an exemplary embodiment of a method for tracking the current directory;

FIG. 3 illustrates an exemplary embodiment of a method for using link information to identify files; and

FIG. 4 is a high level block diagram showing a computer. To facilitate understanding, identical reference numerals have been used, where possible, to designate identical elements that are common to the figures.

### DETAILED DESCRIPTION OF THE INVENTION

The invention will be primarily described within the general context of exemplary embodiments of methods of compile target and compiler flag extraction in program analysis and transformation systems; however, those skilled in the art and informed by the teachings herein will realize that the invention has many applications, including identifying and recording information for compiling source code, program analysis and transformation (e.g., Proteus), static analysis, source code builds (e.g., make files), and other applications for many different kinds of source code (e.g., C/C++), operating systems (e.g., UNIX), file systems (e.g., directory structure) and computer systems (e.g., mainframes, PCs).

A. File and Compile Flag Identification

A.1 Overall Approach

Large software projects typically contain a large number of source files in many directories. These source files may be used to build multiple programs of different functionalities and multiple versions (for different platforms, for example) of the same program. In order to identify source files associated with each program, source files are typically placed in a well-designed directory structure. But, associating files with programs based purely on directory structure is not enough, as a single file can be used in multiple programs and some programs can use dynamically generated files that are placed in some temporary directories (for example, when lex/yacc are used). Additionally, a single make command may generate multiple programs and libraries. Therefore, it is not always straightforward to identify which file is used in what program. It is also not easy to identify the compile time flags used for each file simply by looking at make files. Each directory may contain its own make file and define compile flags specific to that directory. During the build process, files in a directory are compiled with flags specified by the local make file as well as those inherited from make files in parent directories. It can be quite cumbersome to follow the make files and determine compile flags for each file.

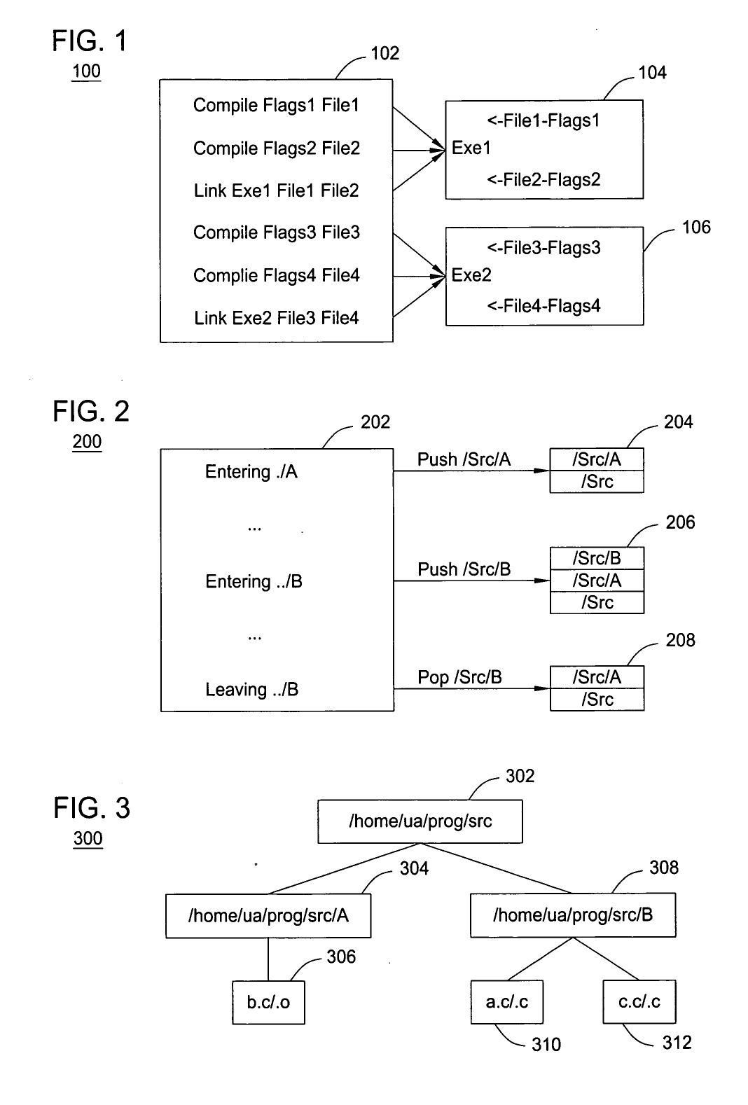

Instead of analyzing each make file, attention should be directed to the output of the build process. Typically, the build process follows make file instructions and issues commands such as compile, link, create, delete, move files, change the current working directory, and the like. These commands are generally printed on the standard output. In an exemplary embodiment, these outputs are examined and files that got compiled and linked into the program or programs are extracted as well as the compile flags used. One exemplary method is to identify compile and link commands in the output and extract the file being compiled, the compile time flag used, and the files linked into an executable or a library. FIG. 1 illustrates this overall approach 100.

FIG. 1 illustrates an overall approach of exemplary embodiments for extracting information from an exemplary build output file 102. The build output file 102 shows excerpts of build output for an exemplary project, such as compile and link commands. The build output file 102 is used to determine which source code files correspond to which object code files. In this example, information is extracted for two executables: information for executable one (Exe1) 104 and information for executable two (Exe2) 106. The information for Exe1 104 indicates that executable one is created from files File1 and File2, having associated compile flags Flags1 and Flags2 respectively. The information for Exe2 106 indicates that executable two is created from files File3 and File4, having associated compile flags Flags3 and Flags4 respectively. The compile and link commands in the build output file 102 are used to determine which source files correspond to which executables being built. While this overall approach is illustrated for a simple example of two executables, it is applicable to builds having any number of various different commands, files, and flags.

A.2 Keeping Track of the Current Working Directory

The compiled files and include flags (e.g., -I in C compilers) can be specified using a relative path, such as “../../../A/B/C/file.c” and “-I../../../A/B/include”. In such cases, it is desirable to keep track of the current working directory to obtain the absolute path and filename. For example, if the current working directory is /A/B/D, the file name and the include option mentioned above becomes “/A/B/C/file.c” and “-I/A/B/include”. This can be done through simple string concatenation or system calls, such as “realpath” in UNIX.

During the build process, changes in the current working directory are typically reflected on the standard output stream. While different build tools reflect this information in slightly different ways, they do exhibit a relatively common behavior. The build process keeps a stack of directories, with the top of the stack being the current working directory. When entering a directory, the new directory is put on top of the stack. When exiting the current directory, the top of the stack is removed and the working directory becomes the next element in the stack. When performing such push and pop operations, the build system typically outputs the pushed/popped directories and often uses relative path. For example, output may include “Entering directory ../../A/B/src” “Leaving directory ../../A/B/src”.

FIG. 2 illustrates an exemplary embodiment of a method 200 for tracking the current directory. In this example, a build output file 202 includes a series of outputs of pushed/popped directories. Initially, /Src is on the stack. When directory ../A is entered, /Src/A is pushed onto the stack at 204. When directory ../B is entered, /Src/B is pushed onto the stack at 206. When directory ../B is left, /Src/B is popped from the stack at 208.

One exemplary embodiment is a method of tracking the current directory throughout a build process 200 by examining the build output file 202. For example, a make file may issue a change directory command and use relative paths for filenames. When examining a particular point in the build output file 202, it is desirable to know what the current working directory is. FIG. 2 illustrates an example of how this is implemented. In this example, the starting directory /Src is pushed onto a stack, which is a data structure stored in memory. In the excerpt of the build output file 202 shown, the line “Entering ./A” refers to “./A”, which is a subdirectory below the starting directory. When this line is examined at 204, “/Src/A” is pushed onto the stack. When line “Entering ../B” is examined, it is determined that “../B” indicates one directory up from the current directory and, then, down to subdirectory B and “/Src/B” is pushed onto the stack at 206. At this point in the example, the stack has grown and now has three elements. Continuing to parse through the build output file 202, “Leaving ../B”, causes “/Src/B” to be popped from the stack at 208, leaving two elements in the stack. The stack is useful when examining commands in the build output file 202, such as compile and link commands that have relative paths for filenames. The stack is used to determine the absolute paths corresponding to the relative paths.

To keep track of the current working directory at each point in the build process, first the initial directory is obtained, i.e., the directory in which the build process started. This can be done through command line options passed to an analysis tool. Then, as each line of the build output is examined, directory changes are identified and appropriate updates are made to a stack to mimic the directory stack maintained during the build process. Specifically, when entering a new directory, the absolute directory of the entered directory is calculated and pushed onto a stack. Upon leaving a directory, the stack is simply popped. Using this technique, the current working directory can be determined at each line of the build output, allowing the absolute file names and directory names to be obtained based on relative paths in compile time flags.

A.3 Extracting Compile Time Flags

A single program is generally built using a limited set of compilers. The exact compile command is then used to identify the compile command in the make output. The file being compiled is specified by the compile command and is, therefore, easy to identify. In addition, -D and -I flags may be identified. The -D flag defines a C macro, whereas the -I flag defines a path to search for the #include directives. The -D flags may effect whether a particular #ifdef evaluates to true or not and, therefore, is used to obtain the correct code version. The -I flags determine which directories to search for an included file and in which order. As two header files of the same name may reside indifferent directories and in each header file, so different macros can be defined and undefined. The -I flag is also used to obtain the right code version. In order to extract appropriate -I and -D flags, the current working directory is tracked and any relative path is converted to an absolute path, making the result much easier to understand.

A.4 Identifying Source Files Used in a Program

FIG. 3 illustrates an exemplary embodiment of a method for using link information to identify files. A parent directory 302 has subdirectories 304, 308 containing object and source files, e.g. files “b.c”, “b.o” 306, “a.c”, “a.o” 310, “c.c”, and “c.o” 312. A link command in a build output file 102 (see FIG. 1) includes a list of one or more object files and a compile command lists one or more source files.

The executable of a program is typically created by linking a set of object files that are the result of compilation. The link command contains the name of the executable as well as a set of object files and both can be specified using relative paths. In this exemplary embodiment, the link command, extract executable names, and object files are identified. While keeping track of the current working directory, the absolute path is determined for the object files. Then, the object file name and its path are used to locate related source files, using a mapping between source files and object files obtained while analyzing compile commands. Thus, it is determined which source file is used in building a particular executable. For example, if the link command is “gcc -o edit a.o ../A/b.o c.o” and the current directory is “/home/ua/prog/src/B”, then the executable is located at “/home/ua/prog/src/B/edit” and the tree object files used are: “/homelua/prog/sec/B/a.o”, “/home/ua/prog/src/A/b.o”, and “/home/ua/prog/src/B/c.o”. Because these three object files are compiled during the make process, their corresponding source files are identifiable. In this example, the corresponding source files are: “/home/ua/prog/src/B/a.c”, “/home/ua/prog/src/A/b.c”, and “/home/ua/prog/src/B/c.c”. Therefore, these three “.c” files are used in building the executable “edit”. This is illustrated in FIG. 3.

B Formats for Information Storage

In this exemplary embodiment, after extracting relevant files and the compile time flags, the relevant files and compile time flags are stored in an XML data format so that it can be used for any program analysis and/or transformation tool. In this format, each file has its own section, specifying the complete file name (including absolute path) as well as its compile time flags. An option is provided to specify common options across all files. An example is shown in Table 1.

TABLE 1
Exemplary XML code for specifying formats for information storage.

```
  <file>
    <path>/A/B/C/D.c</path>
    <options>
        <include>/A/B/C/include</include>
        <define>A=1</define>
    </options>
  </file>
<default_options>
  <include>/A/B/include</include>
  <define>C</define>
</default_options>
```

Table 2 illustrates a simple example of build output for a build that contains only one executable and has a directory structure that needs to be tracked. However, exemplary embodiments are especially advantageous for projects that have hundreds or thousands of files (or more).

TABLE 2
Exemplary build output for a simple example

make[1]: Entering directory ‘/home/byao/code/proteus-
src/yatl/testing/regression
/135/src/circle’
g++ -c circle.cpp -DCIRCLE -l../
make[1]: Leaving directory ‘/home/byao/code/proteus-
src/yatl/testing/regression/
135/src/circle’
g++ -c foo.cpp -DFOO -l circle
g++ -c traceTest.cpp -DTRACETEST -l circle
g++ -o exe foo.o traceTest.o ./circle/circle.o

In this example, the directory where make is executed is /home/byao/code/proteus-src/yatl/testing/regression135/src. Note that foo.cpp, circle.cpp, and traceTest.cpp are identified as being used in the executable (“exe”). The #defines and #includes are all appropriately identified in the resulting XML shown in Table 3.

TABLE 3
Resulting XML file for the example of Table 2

<source_files>
<default_options>
<include>./</include>
<include>/usr/include/c++/3.3.3/</include>
<include>/usr/include/c++/3.3.3/i386-redhat-linux</include>
<include>/usr/lib/gcc-lib/i386-redhat-linux/3.3.3/include</include>
</default_options>
<file role= “active”>
<rpath>traceTest.cpp</rpath>
<options>
<include_defaults></include_defaults>
<include>.</include>
<include>circle</include>
<define>TRACETEST</define>
</options>
<member>SLICE1</member>
</file>
<file role= “active”>
<rpath>circle.cpp</rpath>
<options>
<include>.</include>
<define>CIRCLE</define>
</options>
<member>SLICE1</member>
</file>
<file role= “active”>
<rpath>foo.cpp</rpath>
<options>
<include>.</include>
<include>circle</include>
<define>FOO</define>
</options>
<member>SLICE1</member>
</file>
</source_files>

Exemplary embodiments have many advantages, including providing an automated way to identify source files that need to be included for analysis and the compile flags that are used for each file. This technique does not require modification of existing make files (as some conventional techniques do) and provides a generic output that can be applied to any code analysis and transformation tools. Exemplary embodiments identify source files and their compile time flags to prepare source code for processing by any code analysis and transformation system.

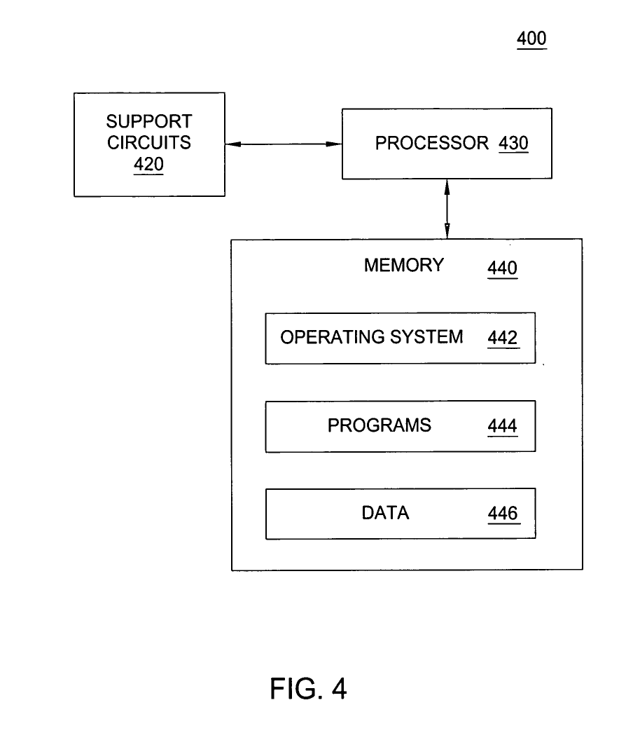

FIG. 4 is a high level block diagram showing a computer. The computer 400 may be employed to implement embodiments of the present invention. The computer 400 comprises a processor 430 as well as memory 440 for storing various programs 444 and data 446. The memory 440 may also store an operating system 442 supporting the programs 444.

The processor 430 cooperates with conventional support circuitry such as power supplies, clock circuits, cache memory and the like as well as circuits that assist in executing the software routines stored in the memory 440. As such, it is contemplated that some of the steps discussed herein as software methods may be implemented within hardware, for example, as circuitry that cooperates with the processor 430 to perform various method steps. The computer 400 also contains input/output (I/O) circuitry that forms an interface between the various functional elements communicating with the computer 400.

Although the computer 400 is depicted as a general purpose computer that is programmed to perform various functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware, or a combination thereof.

The present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media or other signal bearing medium, and/or stored within a working memory within a computing device operating according to the instructions.

What is claimed is:

1. A method, comprising:
identifying a plurality of source file names and a plurality of associated compile time flags by examining a build output file, the source file names naming each file used in building at least one executable program with the associated compile time flags;
resolving any relative path in the source file names to an absolute path to produce absolute source file names; and
recording the absolute source file names and the associated compile time flags in a data format that is stored on a storage device.

2. The method of claim 1, wherein resolving any relative path is performed by keeping track of a current working directory, while examining the build output file.

3. The method of claim 2, wherein keeping track of the current working directory is performed by:
pushing an initial directory on a stack; and
pushing a new directory on the stack, when entering the new directory in the build output file; and
popping an old directory off the stack, when exiting the old directory in the build output file;
wherein the top of the stack is the current working directory.

4. The method of claim 1, further comprising:
determining a plurality of object code file names corresponding to the absolute source file names.

5. The method of claim 1, wherein the data format is readable by a code analysis and transformation system.

6. The method of claim 5, wherein the data format is XML.

7. A computer-readable medium storing a plurality of instructions for performing a method, the method comprising:
identifying a plurality of source file names and a plurality of associated compile time flags by examining a build output file, the source file names naming each file used in building at least one executable program with the associated compile time flags;
resolving any relative path in the source file names to an absolute path to produce absolute source file names; and
recording the absolute source file names and the associated compile time flags in a data format that is stored on a storage device.

8. The computer-readable medium of claim 1, wherein resolving any relative path is performed by keeping track of a current working directory, while examining the build output file.
